(19) United States
(12) Patent Application Publication
(10) Pub. No.: US 2026/0257139 A1
(43) Pub. Date: Sep. 3, 2026

(54) MODULAR SOUND SYNTHESIS SYSTEM USING SENSOR INPUTS

(71) Applicant: HARMAN INTERNATIONAL INDUSTRIES, INCORPORATED, Stamford, CT (US)

(72) Inventors: Kevin J. BASTYR, Franklin, MI (US); Srinath ARUNACHALAM, Dallas, TX (US); Kadagattur Gopinatha SRINIDHI, Novi, MI (US)

(21) Appl. No.: 19/489,153

(22) PCT Filed: Jun. 23, 2023
(86) PCT No.: PCT/US2023/026155

§ 371 Date: Dec. 1, 2025

(51) Int. Cl. A63H 5/00

(52) U.S. Cl. CPC A63H 5/00; A63H 2200/00

(57) ABSTRACT

Various embodiments disclose a computer-implemented method comprising generating, based on a first audio synthesis configuration, an arrangement including at least one audio object to synthesize an audio signal, receiving sensor data acquired from a set of sensors, modifying the arrangement based on the sensor data to generate a modified arrangement, activating the modified arrangement to generate a synthesized audio signal, and outputting, using an audio output device, an audio reproduction of the synthesized audio signal.

### BACKGROUND

### Field of the Various Embodiments

The various embodiments relate generally to sound synthesis systems and, more specifically, to a sound synthesis system using sensor inputs.

### DESCRIPTION OF THE RELATED ART

Various consumer devices output sound to enhance the user experience when interacting with the consumer device. For example, various products produce sound to entertain users. In such products, a sound-producing circuit stores a pre-recorded sound file. When the product receives an input, such as a button press, the sound-producing circuit loads the pre-recorded sound file and drives a speaker to output an audio reproduction of the sound file.

At least one drawback of conventional sound producing devices is that such devices have limited ability to play multiple sounds. For example, pre-recorded sounds require a large amount of storage space, requiring sound producing devices that play a large number of sounds to include large amounts of storage, limiting the range of devices that can be used to produce all of these sounds. Some devices use low-power microcontrollers or storage systems to minimize costs; however, the limited storage and processing capacity of such systems limits the device to reproducing sound from only a limited number of stored audio files. In addition, conventional sound producing devices are not able to alter the output of the pre-recorded sounds other than in simple ways, such as changing a volume or a playback rate, resulting in the device repetitively reproducing sounds with essentially the same characteristics, which detracts from versatility and the long-term entertainment value of the device.

In light of the above, more effective techniques to store and generate a range of sound outputs in consumer devices would be useful.

### SUMMARY

Various embodiments disclose a computer-implemented method comprising generating, based on a first audio synthesis configuration, an arrangement including at least one audio object to synthesize an audio signal, receiving sensor data acquired from a set of sensors, modifying the arrangement based on the sensor data to generate a modified arrangement, activating the modified arrangement to generate a synthesized audio signal, and outputting, using an audio output device, an audio reproduction of the synthesized audio signal.

Further embodiments provide, among other things, non-transitory computer-readable storage media storing instructions for implementing the method set forth above, as well as an interactive toy, a device, and a system configured to implement the method set forth above.

At least one technological advantage of the sound synthesis application relative to the prior art is that, with the disclosed techniques, the sound synthesis application can generate a large variety of sounds in real time using a small microprocessor and memory. Another advantage is that the sound synthesis application is able to alter the generated sound based on sensor inputs so as to customize the sound based on changes in the environment. Generating sounds based on environmental factors enables the sound synthesis application to generate multiple sound outputs or non-repetitive sound outputs with a wide range of characteristics using a limited library of data stored in the memory. Such techniques increase the variety of sounds that the device can produce, increasing the usefulness of the device producing the synthesized sounds. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a conceptual block diagram of a sound synthesis system configured to implement one or more aspects of the present disclosure;

FIG. 2 illustrates a block diagram of an exemplary signal flow executed by the sound synthesis system of FIG. 1, according to various embodiments of the present disclosure;

FIG. 3 illustrates a block diagram of the sound synthesis application of FIG. 1 generating a synthesized audio signal based on values included in sensor data acquired by a set of sensors, according to various embodiments of the present disclosure;

FIG. 4 illustrates a block diagram of the sound synthesis application of FIG. 1 generating a synthesized audio signal based on a selected signal flow acquired from a proximate external device, according to various embodiments of the present disclosure; and

FIG. 5 sets forth a flow diagram of method steps for synthesizing an audio signal based on sensor inputs for output by an audio output device, according to various embodiments of the present disclosure.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### Overview

Embodiments disclosed herein include a sound synthesis system that includes a client computing device that acquires sensor data from one or more sensors and based in part on values from the sensor data, synthesizes an audio output signal for an audio output device. A sound synthesis application executing on the client computing device loads from memory an audio synthesis configuration. The audio synthesis configuration includes tuning parameters, a signal flow that specifies a set of audio objects, and/or control signal values that, in conjunction, synthesize an audio signal. The audio synthesis configuration specifies which audio objects from a library of predefined audio objects are to be used and specifies one or more synthesis parameter values, which modify how the respective audio objects operate. Based on the audio synthesis configuration, the client computing device configures the operation and connections of one or more audio objects in the manner specified in the signal flow. The sound synthesis application uses the configured audio objects to synthesize the audio signal in real time. In various embodiments, some of the control signals are functions of values acquired from sensor data acquired by one or more sensors. In such instances, the sound synthesis application uses values from the sensor data to modify the control signals that operate the audio objects, thereby modifying the synthesized audio signal generated by the audio synthesis configuration.

For example, the client computing device receives sensor data from a set of sensors that provide distinct sensor values, such as a microphone that acquires environmental sounds and a light detector that measures environmental luminance. The sound synthesis application loads an audio synthesis configuration that specifies a set of synthesis parameter values as functions of the sensor data, such as waveform generators that modify the gain values of an audio signal as a function of luminance and filters that modify filter coefficients as a function of detected environmental noise. When the sound synthesis application activates the audio synthesis configuration to synthesize the audio signal, the synthesized audio signal is a function of sensor data values included in the acquired sensor data; the characteristics of the synthesized audio signal change as the sensor data values change. In this way, the sound synthesis application generates interactive sounds as a function of the environment and provides a way for the client computing device to continually change the audio output that is produced in real-time.

The sound synthesis system can be implemented in various forms, such as an interactive device including a processor and local memory, personal computers, and so forth. For example, the sound synthesis system can be incorporated in one or more interactive toys (e.g., a bird toy including a voice box). Additionally or alternatively, in some embodiments, the sound synthesis system can be incorporated into other types of non-toy consumer devices. The sound synthesis system can perform the processing functions using a dedicated processing device and/or a separate computing device, such as a mobile computing device of a user or a cloud computing system. The sound synthesis system can detect various environmental values using any number of sensors of various types, which can be attached to, integrated with other system components, or disposed separately.

### System Overview

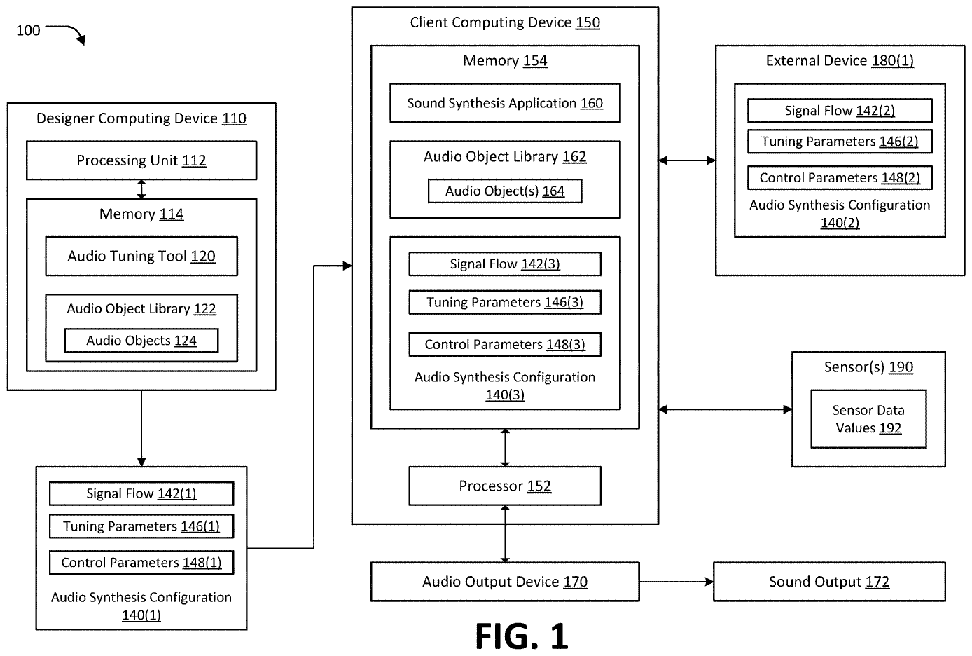

FIG. 1 illustrates a conceptual block diagram of a sound synthesis system 100 configured to implement one or more aspects of the present disclosure. As shown, the sound synthesis system 100 includes, without limitation, a designer computing device 110, an audio synthesis configuration 140(1), a client computing device 150, an audio output device 170, one or more external devices 180 (e.g., 180(1), 180(2), etc.), and one or more sensors 190. The designer computing device 110 includes, without limitation, a processing unit 112 and a memory 114. The memory 114 includes, without limitation, an audio tuning tool 120 and an audio object library 122 including one or more audio objects 124. The client computing device 150 includes, without limitation, a memory 154, and a processor 152. The memory 154 includes, without limitation, a sound synthesis application 160, a local audio object library 162 including one or more audio objects 164, and a local audio synthesis configuration 140(3) 166. The one or more external devices 180 include, without limitation, one or more audio synthesis configurations 140(2). The one or more sensors 190 include, without limitation, one or more sensor data values 192. One or more of the audio synthesis configurations 140(2) respectively include, without limitation, a signal flow 142(2), one or more tuning parameters 146(2), and one or more control parameters 148(2).

In operation, the audio tuning tool 120 executing on the designer computing device 110 accesses the audio object library 122 to generate an audio synthesis configuration 140. For example, a designer can use the audio object library 122 to specify which audio objects 124 from the audio object library 122 to use when generating sounds. The audio synthesis configuration 140(1) includes a set of tuning parameters 146(1), a set of control parameters 148(1), and a signal flow 142(1) providing a configuration of one or more audio objects that are in the audio object library 122. The audio synthesis configuration, upon activation, generates a synthesized audio signal.

The designer computing device 110 transmits the audio synthesis configuration 140(1) to the client computing device 150 for storage as one of a group of locally stored audio synthesis configurations 140 (e.g., the audio synthesis configuration 140(3)). The sound synthesis application 160 executing on the client computing device 150 generates a synthesized audio signal based on one of the stored audio synthesis configurations 140(3). When synthesizing an audio signal for output, the sound synthesis application 160 selects an audio synthesis configuration from the set of stored audio synthesis configurations 140(3). The selected audio synthesis configuration specifies one or more audio objects defined in the audio object library 162 and connections between the audio objects. The selected audio synthesis configuration 140(3) also specifies one or more sensor data values 192 that control one or more synthesis parameters that the audio synthesis configuration uses when synthesizing the audio signal.

The sound synthesis application 160 configures the local audio objects 164 in an arrangement corresponding to the selected audio synthesis configuration (e.g., the signal flow, tuning parameters, and control signals), where the sound synthesis application 160 generates the arrangement as specified by the signal flow and uses synthesis parameters as modified by the tuning parameters and/or the control parameters. For example, the sound synthesis application 160 can be an extendable audio framework (xAF) application produced by Harman International®. The sound synthesis application 160 acquires sensor data from the sensors 190 and extracts the applicable sensor data values 192 from the sensor data. The sound synthesis application 160 updates the arrangement using the sensor data values 192 and causes the updated and/or modified arrangement to produce a synthesized audio signal. The sound synthesis application 160 drives the audio output device 170 to provide a sound output 172 that is a reproduction of the synthesized audio signal.

Designer computing device 110 is a computing device that a designer uses to generate an audio synthesis configuration 140(1). In various embodiments, the designer computing device 110 communicates with the client computing device 150 directly or via a network (not shown) to update the client computing device 150 with the sound synthesis application 160, the audio object library 162 (e.g., a copy of or a subset of the audio object library 122), and/or the audio synthesis configuration 140.

The processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a system on a chip (SoC), or a CPU configured to operate in conjunction with a GPU. In general, the processing unit 112 can be any technically feasible hardware unit capable of processing data and/or executing software applications.

The memory 114 can include a random-access memory (RAM) module, a flash memory unit, or any other type of memory unit or combination thereof. The processing unit 112 is configured to read data from and write data to the memory 114. In various embodiments, the memory 114 includes non-volatile memory, such as optical drives, magnetic drives, flash drives, electrically erasable programmable read-only memory (EEPROM) or other storage. In some embodiments, separate data stores, such as external data stores included in a network (“cloud storage”) can supplement or constitute the memory 114. In some embodiments, the audio tuning tool 120 within the memory 114 can be executed by the processing unit 112 to implement the overall functionality of the designer computing device 110. In various embodiments, an interconnect bus (not shown) connects the processing unit 112, the memory 114, and any other components of the designer computing device 110.

The audio tuning tool 120 generates one or more audio synthesis configurations 140 (e.g., the audio synthesis configuration 140(1)), where a given audio synthesis configuration 140 specifies how a computing device (e.g., the designer computing device 110, the client computing device 150, external devices 180, etc.) is to synthesize an audio signal for playback using a set of predefined audio objects and synthesis parameters. In various embodiments, the designer computing device 110 uses the audio tuning tool 120 to generate an audio synthesis configuration and simulate the operation of the client computing device 150 and/or the sensors 190 to simulate the reproduction of the sound output 172 based on the generated audio synthesis configuration. For example, the audio tuning tool 120 can be a graphical user interface, such as the Global Tuning Tool (GTT) produced by Harman International, that enables users to visually load predefined audio objects and add connections between the audio objects and configure tuning parameters. In various embodiments, the audio tuning tool 120 enables a designer to modify synthesis parameters used by the predefined audio objects when synthesizing a sound. For example, the audio tuning tool 120 can load a waveform generator from the audio object library 122 and can modify the synthesis parameters (e.g., amplitude, frequency, waveform type, phase, etc.) employed by the waveform generator when synthesizing a waveform.

The audio object library 122 includes predefined audio objects that act as sound synthesis blocks that can be combined to generate a sound. For example, the audio object library 122 defines the functionalities of various audio objects including pink and white noise generators, waveform generators (oscillators, triangle wave generators, etc.), amplitude controls (e.g., gain, volume, mute, limiter and envelope), mixers to combine signals, control signal mixers, routers, scalers, splitters and selectors, control signal modulators, control signal generators, control signal tables, distortion effects, delay elements, music file players, lookup tables (LUTs), frequency equalization blocks, and filters, including high-pass filters (HPF), low-pass filters (LPF), bandpass filters (BP), shelf filters, biquads, finite impulse response (FIR) filters, and so forth. These various audio objects are embodied in lines of code that, when executed, process, generate, filter or otherwise create and/or modify the audio or control signals using their accompanying tuning parameters and control signals as inputs. In various embodiments, the audio tuning tool 120 displays the audio objects from the audio library for use in generating an audio synthesis configuration (e.g., the audio synthesis configuration 140(1)).

The audio synthesis configuration 140 (e.g., the audio synthesis configurations 140(1), 140(2), 140(3), etc.) includes one or more files that specify the arrangement of audio objects (e.g., a listing of audio objects and interconnections) and synthesis parameters required to synthesize an audio signal. The audio synthesis configuration 140 specifies a subset of audio objects from an audio object library 122 via a signal flow 142, which also specifies the interconnections between the audio objects. The audio synthesis configuration 140 also specifies synthesis parameters (e.g., control parameters 148, tuning parameters 146, and/or inputs from sensor data values 192) that the specified arrangement is to use to generate a specific sound. In various embodiments, the audio synthesis configuration 140 includes a number of synthesis parameters that configure the audio objects. For example, the audio synthesis configuration 140(1) includes, in addition to the signal flow 142(1), a set of tuning parameters 146(1) that includes, among other things, gain values, frequencies, envelope parameters such as amplitude-vs-time values, frequency modulation parameters, filter coefficients, filter corner frequencies, Qs and gains, limiter profiles, distortion coefficients, length of delay (in ms or s), and/or lookup tables. In another example, the audio synthesis configuration 140(1) includes a set of control parameters 148(1), such as “enable,” “disable,” or “mute” controls that control the functionality of individual objects, table index values to select which table of tuning parameters associated with an audio object are selected as “active,” “loop,” or “one-shot,” to determine an operating state of an audio object, etc.

In various embodiments, a designer can produce a large number of distinct audio synthesis configurations that the client computing device 150 stores locally as the audio synthesis configurations 140 (e.g., 140(3)-140(X)). In such instances, the sound synthesis application 160 loads one of the locally stored audio synthesis configurations 140 (e.g., 140(3)) and generates an arrangement and parameters that are specified in the audio synthesis configuration 140(3) to synthesize a particular audio signal. In some embodiments, the audio synthesis configuration 140 can include multiple files. For example, a given audio synthesis configuration 140 can include one file (e.g., a signal flow diagram [.sfd] file) that specifies the audio objects, connections between the audio objects and control signals that are to be used in an arrangement of audio objects, and a separate file (e.g., a set of tuning parameters [.set] files) that specifies the synthesis parameters that configure the respective audio objects.

The client computing device 150 is a device that executes the sound synthesis application 160 and drives the audio output device 170 to generate the sound output 172. In various embodiments, one or more of the client computing device(s) 150, sensor(s) 190, and/or audio output device(s) 170 are included in one or more devices, such as such as an interactive device, soundbar, portable speaker, smart home devices (e.g., digital assistants). In some embodiments, the client computing device 150 can be a consumer product, such as an interactive toy (e.g., a race car that produces a sound). In various embodiments, the client computing device 150 is located in various environments including, without limitation, indoor environments (e.g., living room, bedroom, classroom, etc.), and/or outdoor environments, (e.g., patio, garden, etc.). In some embodiments, the client computing device 150 could be a low-power, limited processing, and/or limited memory device that implements a lightweight processing of incoming data. For example, client computing device 150 could be a Raspberry Pi (e.g., Pi 1®, Pi 2®, Pi 3®, or Pi 4®) that includes a processor such as a digital signal processor, memory (e.g., 1-4 MB RAM), and storage (e.g., a flash storage card). For example, the client computing device 150 could be a development board, such as a Teensey® 4.0 microcontroller development board, or any other board that contains a processor that is used as a digital signal processor, such as an ARM® Cortex M4, or other lightweight computing devices.

The processor 152 be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU. In general, the processing unit 112 can be any technically feasible hardware unit capable of processing data and/or executing software applications. In some embodiments, the processor 152 could be a low-power processor. In such instances, the digital signal processor performs lightweight computations, including real-time processing of sensor data and/or electrical signals to generate an audio signal.

The memory 154 can include a random-access memory (RAM) module, a flash memory unit, an EEPROM, or any other type of memory unit or combination thereof. The processor 152 is configured to read data from and write data to the memory 154. In various embodiments, the memory 154 includes non-volatile memory, such as optical drives, magnetic drives, flash drives, or other storage. In some embodiments, separate data stores, such as external data stores included in a network (“cloud storage”) can supplement or constitute the memory 154. In some embodiments, the sound synthesis application 160 within the memory 154 can be executed by the processor 152 to implement the overall functionality of the client computing device 150. In various embodiments, an interconnect bus (not shown) connects the processor 152, the memory 154, and any other components of the client computing device 150.

The sound synthesis application 160 executes various techniques to synthesize an audio signal and drive the audio output device 170 to reproduce the synthesized audio signal as the sound output 172. In various embodiments, the sound synthesis application 160 stores one or more audio synthesis configurations 140 (e.g., 140(3)-140(X)) received from external sources, including receiving the audio synthesis configuration 140(1) from the designer computing device 110 and/or receiving the audio synthesis configuration 140(2) stored in the external device 180. For example, the sound synthesis application 160 can cause the client computing device 150 to download the audio synthesis configuration 140(2) from the external device 180 when proximate to the external device 180. In some embodiments, the client computing device 150 downloads and stores multiple audio synthesis configurations from one or more external devices 180 (e.g., 180(1), 180(2), etc.). In various embodiments, the sound synthesis application 160 causes the client computing device 150 to locally store the received audio synthesis configurations 140(1), 140(2) as one or more audio synthesis configurations 140 (e.g., 140(3)-140(X)) within the memory 154.

In various embodiments, the sound synthesis application 160 initiates the sound output 172 by producing an arrangement of audio objects 164 in the manner specified in a given audio synthesis configuration 140 and activating the arrangement to synthesize an audio signal. The sound synthesis application 160 then drives the audio output device 170 to reproduce the synthesized audio signal as the sound output 172. In various embodiments, the sound synthesis application 160 responds to real-time changes in the environment by processing sensor data received proximate to the time of sound playback and changing the how the arrangement of audio objects 164 synthesizes an audio signal. For example, the sound synthesis application 160 can input sensor data values 192 received from the sensors 190 to change one or more synthesis parameters (e.g., the tuning parameters 146(3) and/or the control parameters 148(3)) associated with the arrangement of audio objects 164, specified by the signal flow 142(3), that is synthesizing the audio signal. In such instances, the sound synthesis application 160 responds to changes in the sensor data values 192 by modifying how the synthesis parameters operate with the arrangement of audio objects 164, thereby modifying the arrangement of audio objects 164 and modifying the synthesized audio signal.

The audio synthesis configurations 140 (e.g., 140(3)-140(X)) are locally stored in the memory 154 of the client computing device 150. In various embodiments, the audio synthesis configurations 140 includes a default audio synthesis configuration that the sound synthesis application 160 loads without intervention, and one or more additional audio synthesis configurations that the sound synthesis application 160 selects in response to intervention by the user (e.g., providing an input to select a non-default audio synthesis configuration). In various embodiments, the audio synthesis configurations 140 stored in the client computing device 150 correspond to the audio synthesis configuration 140(1) created by the designer computing device 110, and/or the audio synthesis configuration 140(2) or components (e.g., the signal flow 142(2), etc.) that were stored in other external devices 180 and copied to the client computing device 150.

The audio output device 170 includes a device capable of providing a sound output, such as a loudspeaker. For example, the audio output device 170 could be headphones, ear buds, a wired or wireless speaker system (e.g., one or more loudspeakers, amplifier, etc.), or any other device that generates the sound output 172. In various embodiments, the audio output device 170 can be incorporated into client computing device 150 (e.g., disposed in the body of a form factor including the processor 152 and the audio output device 170), or can be external to the client computing device 150. In various embodiments, the audio output device 170 is implemented using any number of different conventional form factors, such as a single consumer product, discrete loudspeaker devices, personal speakers, body-worn (head, shoulder, arm, etc.) speaker devices, and so forth. In some embodiments, the audio output device 170 can be connected to output devices that additionally provide other forms of outputs, such as display devices that provide visual outputs.

The external device(s) 180 includes one or more objects that store audio synthesis configurations 140 (e.g., 140(2)). For example, the external device 180 can be a consumer device that includes a memory (not shown) that stores the audio synthesis configuration 140(2). In some embodiments, the external device 180 can be an object that includes an affixed tag (e.g., barcode, QR code, RFID tag, label, etc.) that includes an encoded version of portions or all of an audio synthesis configuration, such as the audio synthesis configuration 140(2), the signal flow 142(2), the tuning parameters 146(2), and/or the control parameters 148(2).

In some embodiments, the external device 180 can store all or portions of multiple audio synthesis configurations 140, of which all or a portion are loaded by the client computing device 150 after the client computing device 150 is communicatively coupled to the external device 180. In some embodiments, multiple external devices 180 can be sequentially communicatively coupled to the client computing device 150 for transfer of audio synthesis configurations 140 to be stored locally in the memory 154. In various embodiments, the client computing device 150 can acquire the audio synthesis configuration 140(2) from the external device 180 using various techniques associated with the manner in which the audio synthesis configuration 140(2) is stored. For example, when the audio synthesis configuration 140(2) is encoded in a tag, the client computing device 150 can use a camera, or other appropriate sensor, such as an RFID chip reader, to acquire the tag and extract the audio synthesis configuration 140(2) from the tag. In another example, when the audio synthesis configuration 140(2) is stored in a storage device within the external device 180, the client computing device 150 can establish communications with the external device 180 and download the audio synthesis configuration 140(2). In such instances, the client computing device 150 can limit establishing a communication link with the external device 180 until the sound synthesis application 160 detects that the external device 180 is proximate to the client computing device 150.

The sensor(s) 190 include various types of sensors that acquire sensor data from the environment. For example, the sensors can include auditory sensors, such as microphones, to receive types of sound (e.g., subsonic pulses, ultrasonic sounds, speech commands, etc.). In some embodiments, the sensors 190 optical sensors, such as RGB cameras, time-of-flight cameras, infrared cameras, depth cameras, a quick response (QR) code tracking system, potentiometers, proximity or presence sensors, motion sensors, such as an accelerometer or an inertial measurement unit (IMU) (e.g., a three-axis accelerometer, gyroscopic sensor, and/or magnetometer), pressure sensors, and so forth. In addition, in some embodiments, sensor(s) 190 can include wireless sensors, including radio frequency (RF) sensors (e.g., sonar and radar), and/or wireless communications protocols, including Bluetooth, Bluetooth low energy (BLE), cellular protocols, and/or near-field communications (NFC).

In various embodiments, the sensors 190 provide sensor data that includes a single value (e.g., a sensor data value 192) or a set of sensor data values 192 (e.g., sensor data values 192(1), 192(2), etc.). In such instances, the sensors 190 can transmit the sensor data to the sound synthesis application 160, where the sound synthesis application 160 processes the sensor data to extract the applicable sensor data values 192 and use the sensor data values 192 to modify the operation of an existing arrangement of audio objects 164 specified by the audio synthesis configuration 140.

As will be discussed in further detail below, in various embodiments, a given audio synthesis configuration 140 specifies that the output of an arrangement of audio objects 164 are based on at least one sensor data value 192. For example, the audio synthesis configuration can include one or more synthesis parameters, such as control signals, outputs, tuning parameters, tuning parameter sets, and so forth, that cause the arrangement of audio objects 164 to provide differing outputs based on various sensor data values 192. In such instances, the sound synthesis application 160 uses the sensor data values 192 to modify the audio synthesis configuration. In some embodiments, the computing device 110 includes the sensor data value 192 for use in the creation or tuning of the arrangement of audio objects 164 corresponding to the audio synthesis configuration 140. Additionally or alternatively, the sound synthesis application 160 scales the sensor data values 192 to modify at least one of the parameters associated with the arrangement of audio objects 164.

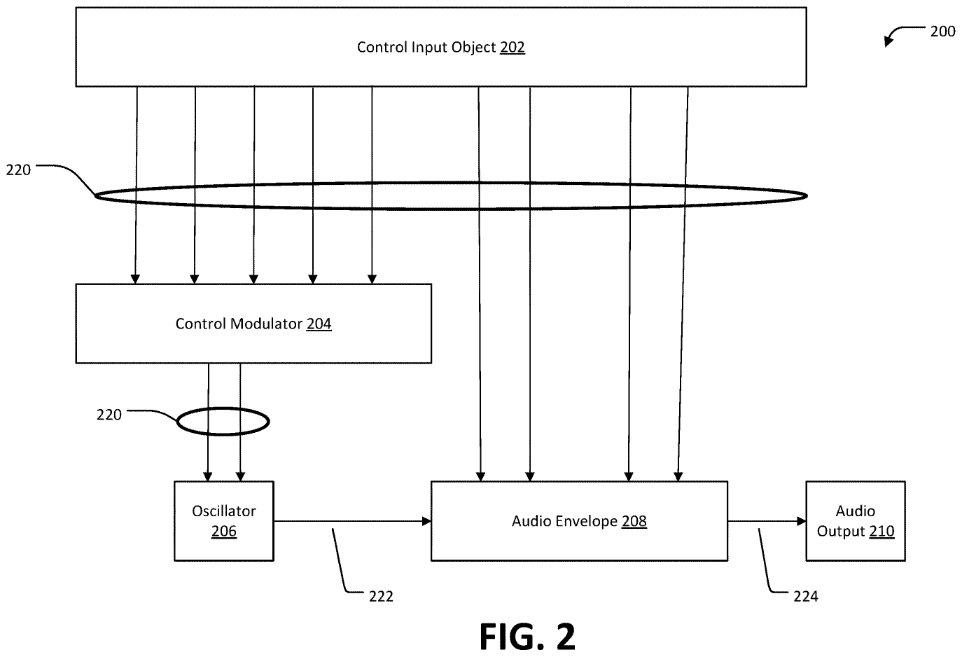

FIG. 2 illustrates a block diagram of an exemplary signal flow 200 executed by the sound synthesis system 100 of FIG. 1, according to various embodiments of the present disclosure. As shown, the signal flow 200 includes, without limitation, a control input object 202, a control modulator 204, an oscillator 206, an audio envelope 208, an audio output module 210, control signals 220, an oscillator audio output signal 222, and a modified oscillator audio output signal 224.

In operation, the sound synthesis application 160 populates the signal flow 200 with a tuning parameter set and a control parameter set to specify an arrangement of audio objects 164 that is to generate a specific synthesized audio signal usable by the audio output device 170 is to output as the sound output 172. In various embodiments, a designer generates the signal flow 200 (e.g., the signal flow 142(1)) using an audio tuning tool 120 to select one or more predefined audio objects 124 from the audio object library 122. In an example, a designer via the audio tuning tool 120, adds various control signal and audio signal connections between the selected audio objects, and specifies how the audio objects 124 are to generate a synthesized audio signal by defining one or more synthesis parameters, including the tuning parameter set and the control parameter set.

The audio objects 202-210 are a subset of predefined audio objects included in the audio object library 122, where the audio objects 124 correspond to the audio objects 164 included in the audio object library 162. The signal flow 200 specifies a specific group of audio objects 202-210 from the audio object library 122 that are to be executed and the routing of control signals 220 to specify an arrangement of audio objects 202-210. The signal flow 200 also specifies audio signals 222, 224 that connect the group of audio objects 202-210. In various embodiments, the signal flow 200 can include other types of audio objects 124. For example, the signal flow 200 can include various noise generators, waveform generators, amplitude controllers, mixers, control signal modulators, frequency equalizers, filters, and so forth to synthesize a synthesized audio signal for output by the audio output device 170.

As shown, the signal flow 200 includes a control input object 202, a control modulator 204, an oscillator 206, an audio envelope 208, an audio output module 210. When activated, the control input object 202 generates a set of control signals. For example, when loaded on the client computer device 150, the control input object 202 is activated by a manual input from the user (e.g., a button press) and can generate initiation control signals 220 that cause one or more of the other audio objects 206, 208 to operate. The oscillator 206 generates an oscillator audio output signal 222 based on the set of tuning parameters. In various embodiments, the oscillator 206 is also based on control parameters that the oscillator 260 receives from the control input object 202. The audio envelope 208 generates a specific time dependent envelope that shapes the oscillator audio output signal 222 to generate a modified oscillator audio output signal 224. The audio output module 210 converts the modified oscillator signal into a synthesized audio signal for output via the audio output device 170.

In some embodiments, the signal flow 200 can be stored as a netlist that specifies the connections between audio objects. In some embodiments, one or more of the audio objects 202-210 includes a set of tuning parameters (e.g., the tuning parameters 146 included in the audio synthesis configuration 140) that configure the parameters used to operate the respective audio objects 202-210. In some embodiments, one or more of the set of tuning parameters are modified by sensor data values 192 provided by the one or more sensors 190. Additionally or alternatively, in some embodiments, the signal flow 200 includes one or more control signals 220 that specify one or more synthesis parameter values as functions of sensor data. For example, the signal flow 200 can specify that the control input object 202 receives various sensor data values 192 (e.g., temperature, luminance, ambient sound level, etc.) and outputs one or more control signals 220 that modify the synthesis parameter values used by one or more of the modules 204-210. For example, the control modulator 204 outputs two control signals that are sent to the oscillator 206. These control signals can vary in time and control the instantaneous frequency and amplitude of the sine wave that are output by the oscillator 206. The control modulator 204 can receive control signals that indicate specific sensor data values 192 associated with lighting and/or motion and can generate one or more control signals for the oscillator 206 that include the influence of specific sensor data values 192. Alternatively, the control modulator 204 can generate a set of control signals specifying synthesis parameters for the oscillator as a function of the sensor data values 192. For example, the control modulator 204 can generate control signals 220 that specify a specific sine wave according to the formula:

$$A sin ( ω t + b ) \qquad Eq . 1$$

Where A is a function of a sensor value acquired from a light sensor and ω is a function of a sensor data value 192 acquired from a motion sensor (e.g., an accelerometer) and b is a function of a sensor data value 192 received from another sensor 190 (e.g., a microphone). In such instances, the oscillator 206 would receive different control signals 220 from the control modulator 204 based on the sensor data received by the control input object 202 and the frequency and amplitude of the output signal 222 vary with the sensor data values 192. In some embodiments, one or more of the control parameters for the audio envelope 208 can be similarly influenced by the sensor data values 192. In this manner, a designer can use the signal flow 200 to output a large range of synthesized audio signals using the same configuration of audio objects 202-210.

In some embodiments, a signal flow includes some of the synthesis parameters, including a tuning parameter set and control signals. In some embodiments, a signal flow includes all the synthesis parameters; in such instances, the sound synthesis application 160 can load the signal flow in lieu of an audio synthesis configuration 140. In some embodiments, the sensor data value 192 may affect a tuning parameter stored in a tuning parameter set without affecting a control signal. In some embodiments, a sensor data value 192 affects a control signal that is used to select some or all of the tuning parameters for an individual audio object, multiple audio objects, or the entire signal flow 200.

In some embodiments, a range of values produced by a sensor is mapped to a range of a control signal. For example, a full-scale sensor output data value 192(1) corresponds to the maximum desired value for the control signal, and a minimum sensor output data value 192(2) corresponds to the minimum desired value for the control signal. In one example, the maximum loudness output signal from a microphone corresponds to a 1 kHz oscillator frequency, while the minimum loudness output signal from the microphone (e.g., the noise floor of the microphone) corresponds to a 100 Hz oscillator frequency. In this way, one or more sensor data values 192 can be scaled or mapped to the range of control signals by a scale factor. The scale factor can be a simple ratio, an offset, or other types of values to modify the sensor data values 192 provided by the sensors 190 or the like. For example, a motion sensor provides an infrared motion sensor data value 192 as either 0 (indicating no motion) or a 1 (indicating motion). This sensor data value 192 can be mapped by the control input object 202 to a control signal that either disables or enables the audio envelope 208. In such instances, motion detected by the infrared motion sensor 190 effectively activates the audio envelope 208, while the audio envelope 208 is inactive when motion is not detected by the infrared motion sensor 190. In an embodiment, a control signal set includes a mix of static parameters and dynamic parameters that are mappings or scaling of sensor data values.

### Sensor-Based Sound Synthesis

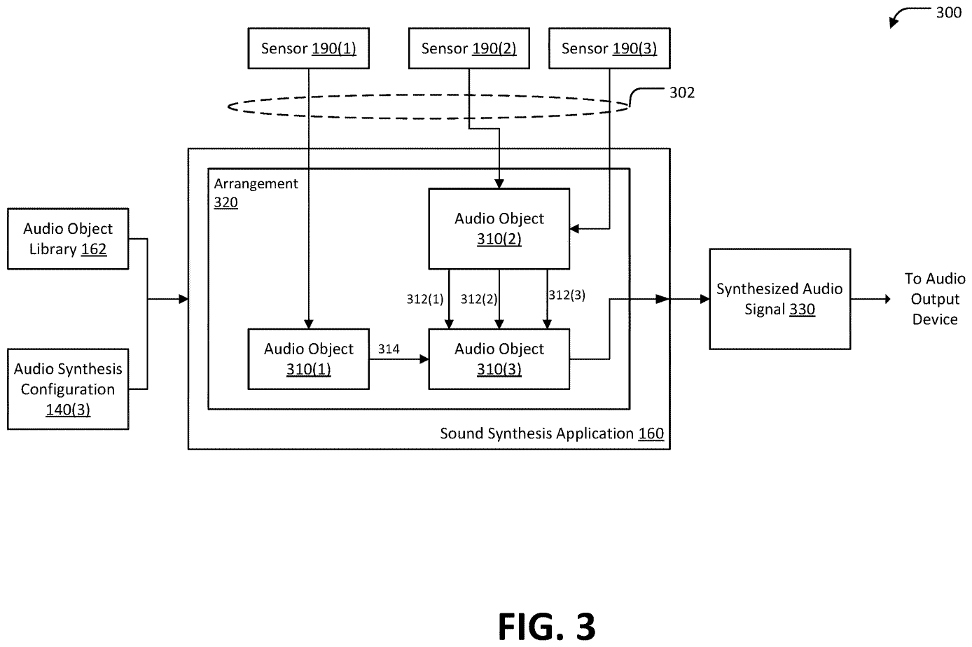

FIG. 3 illustrates a block diagram of the sound synthesis application 160 of FIG. 1 generating a synthesized audio signal 330 based on the sensor data values 192 included in sensor data 302 acquired by a set of one or more sensors 190, according to various embodiments of the present disclosure. As shown, the sound synthesis system 300 includes, without limitation, a set of sensors 190(1)-190(3), the audio object library 162, the audio synthesis configuration 140, the sound synthesis application 160, and the synthesized audio signal 330. The sound synthesis application 160 includes, without limitation, an arrangement 320 including, without limitation, a set of audio objects 310(1)-310(3), a set of tuning parameters (not shown), and a set of and control signals 312(1)-312(3).

In operation, the sound synthesis application 160 selects the audio synthesis configuration 140(3) from the memory 154 of the client computing device 150 to synthesize the synthesized audio signal 330 for output by the audio output device 170. The audio synthesis configuration 140(3) includes a signal flow 142(3) that specifies a group of audio objects 310(1)-310(3) that are to be used and how the audio objects 310(1)-310(3) are connected. The audio synthesis configuration 140(3) also includes and a set of tuning parameters and/or control signals 312(1)-312(3). In various embodiments, the audio synthesis configuration 140(3) includes the tuning parameters 146(3) specifying values for the set of tuning parameters and includes control parameters 148(3) the respective control signals 312(1)-312(3). Each of the audio objects 310(1)-310(3) corresponds to a predefined audio object 164 stored in the audio object library 162. The sound synthesis application 160 loads the group of audio objects 310(1)-310(3) from the audio object library 162 and generates the arrangement 320 of the audio objects 310(1)-310(3) by connecting the audio objects 310(1)-310(3) with the control signals 312(1)-312(3) specified by the audio synthesis configuration 140. When the sound synthesis application 160 receives an indication to produce the synthesized audio signal 330, the sound synthesis application 160 executes the audio synthesis configuration to synthesize the synthesized audio signal 330.

In various embodiments, the sound synthesis application 160 modifies one or more tuning parameters of the audio objects 310(1)-310(3) and/or one or more of the control signals 312(1)-312(3) used to generate the synthesized audio signal 330 as a function of sensor data values 192 included in the sensor data 302 acquired by the set of sensors 190(1)-190(3). In such instances, the sound synthesis application 160 processes the sensor data 302 at the time of sound synthesis when producing the synthesized audio signal 330. The sensor data values 192 in the acquired sensor data 302 modify the tuning parameters of the audio objects 310(1)-310(3) and/or the control signals 312(1)-312(3), producing different synthesized audio signals 330 as a function of different sensor data values 192 in the acquired sensor data 302. In various embodiments, the sensors 190 are connected to analog or digital inputs (not shown) of the client computing device 150. In such instances, the client computing device 150 reads and/or digitizes the signals received from the sensors 190 at a given sample rate. The sound synthesis application 160 inputs the sensor data values 192 from the signals into the audio objects 310.

For example, the sensor 190(1) can be a potentiometer, the sensor 190(2) can be a time-of-flight distance sensor, and the sensor 190(3) can be a microphone. In such instances, the audio object 310(1) (e.g., an oscillator) can generate the audio signal 314 based on a value corresponding to a position of a tunable dial on the potentiometer. The audio object 310(2) (e.g., a control input object 202, or a control modulator) can generate a set of control signals 312(1)-312(3) based on values included in the sensor data 302 acquired by the distance sensor (e.g., control signal 312(1)), the microphone (e.g., control signal 312(2)), or a combination of the sensors (e.g., control signal 312(3)). The set of control signals 312(1)-312(3) modify the synthesis parameters controlled by the audio object 310(3). For example, the audio object 310(3) can be an audio equalizer object that modifies the audio signal 314. In such instances, the audio equalizer modifies the audio signal 314 based on the specific values included in the control signals 312(1)-312(3) by modifying the cut-off frequency, quality factor, and filter order of the equalizer. In such instances, the user can interact with the sensor 190(1) manually to modify the waveform generated to create the synthesized audio signal 330, and can also move the sensor 190(2), 190(3) to different environments, create noise, and/or move objects proximal to the sensors 190(2), 190(3) to also modify the waveform to generate a different synthesized audio signal in real time.

Various types of modulations are possible using sets of tuning parameters and/or data values from the sensors 190 to modify synthesis parameters specified in the audio synthesis configurations 140. For example, when synthesizing an ocean sound, the sound synthesis application 160 uses acquired sensor data 302 to modulate a time duration between waves by modifying the length of audio envelope 208. When synthesizing a bird chirping sound, the sound synthesis application 160 can use a control modulator object to modify the time-varying fundamental sine wave frequency that forms the basis of the bird chip sound. Similarly, when synthesizing a vehicle engine sound, the sound synthesis application can set the engine RPM as a function of a gyroscope sensor output or an accelerometer sensor output.

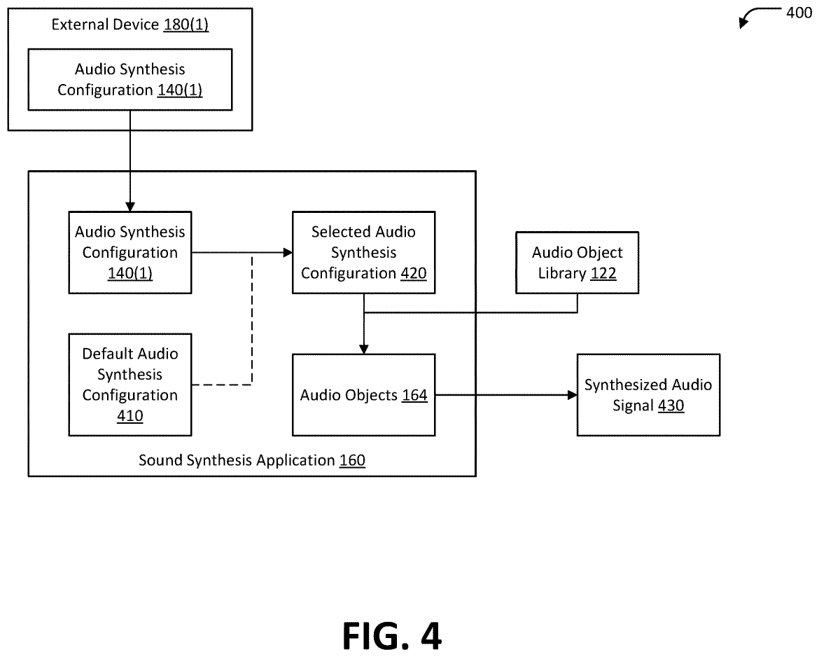

FIG. 4 illustrates a block diagram of the sound synthesis application 160 of FIG. 1 generating a synthesized audio signal based on a selected audio synthesis configuration acquired from a proximate external device, according to various embodiments of the present disclosure. As shown, the example audio synthesis grouping 400 includes, without limitation, the sound synthesis application 160, an external device 180(1), the audio object library 122, and a synthesized audio signal 430. The external device 180(1) includes, without limitation, an audio synthesis configuration 140(1) including a signal flow, a tuning parameter set, and a control signal set. The sound synthesis application 160 includes, without limitation, a default audio synthesis configuration 410, the audio synthesis configuration 140(1), a selected audio synthesis configuration 420 and audio objects 164.

In operation, the sound synthesis application 160 acquires the audio synthesis configuration 140(1) from the external device 180(1). When the sound synthesis application 160 is triggered to begin to generate the synthesized audio signal 430, the sound synthesis application 160 determines which of the group of audio synthesis configurations 140 to select as the selected audio synthesis configuration 420. Upon selecting the selected audio synthesis configuration 420 from the group of stored audio synthesis configurations 140, the sound synthesis application 160 acquires a set of audio objects 164 from the audio object library 122. The sound synthesis application 160 configures the acquired set of audio objects 164 in the manner specified by the selected audio synthesis configuration 420 to generate an arrangement (e.g., the arrangement 320) of audio objects 164 operating based on the signal flow 142(3), a set of tuning parameters 146(3) and a set of control parameters 148(3). The sound synthesis application 160 uses the generated arrangement to produce the synthesized audio signal 430.

In various embodiments, the sound synthesis application 160 performs various techniques to acquire the audio synthesis configuration 140(1) from the external device 180(1). For example, the client computing device 150 can scan a tag in which the audio synthesis configuration 140(1) is encoded. In another example, the client computing device 150 can automatically establish a wireless communications link with the external device 180(1) when proximate to the external device 180(1) with no user action required. In some embodiments, the client computing device 150 can prompt the user to download the audio synthesis configuration 140(1) from the external device 180(1) (e.g., output a tone, provide haptic feedback, output a notification light, etc.). In such instances, the client computing device 150 can receive an authorization input from the user and respond by downloading the audio synthesis configuration 140(1) from the external device 180(1).

In various embodiments, the sound synthesis application 160 can store multiple synthesis configurations, signal flows, tuning parameters, and/or control signals. In some embodiments, the client computing device 150 can acquire multiple audio synthesis configurations 140(1)-140(N) from the designer computing device 110 and/or multiple audio synthesis configurations 140(1)-140(X) from external devices 180(1)-180(Y). In such instances, the sound synthesis application 160 selects one of the stored audio synthesis configurations 140 as the default audio synthesis configuration 410. When the sound synthesis application 160 receives an indication to output an audio output, the sound synthesis application 160 selects the default audio synthesis configuration 410 for configuring a set of audio objects 164 to generate a synthesized audio signal 430.

In some embodiments, the user provides an indication to select one of the stored audio synthesis configurations 140 in lieu of the default audio synthesis configuration 410. For example, the user can select one of the stored audio synthesis configurations 140 from a visual menu. In another example, the user can provide a speech input that the client computing device 150 processes as indicating a selection of a stored audio synthesis configuration other than the default audio synthesis configuration (e.g., “I don't like that sound, play another one,” or “I want to hear the bird chirp!”). In such instances, the sound synthesis application 160 responds to the user indication by selecting one of the stored synthesis configurations as the selected audio synthesis configuration 420. For example, the sound synthesis application 160 can respond to a user indication to select a different synthesis configuration by selecting the audio synthesis configuration 140(1) as the selected audio synthesis configuration 420. The sound synthesis application 160 responds to inputs to output a sound by configuring the audio objects 164 in an arrangement specified by the audio synthesis configuration 140(1) and uses the arrangement to generate the synthesized audio signal 430.

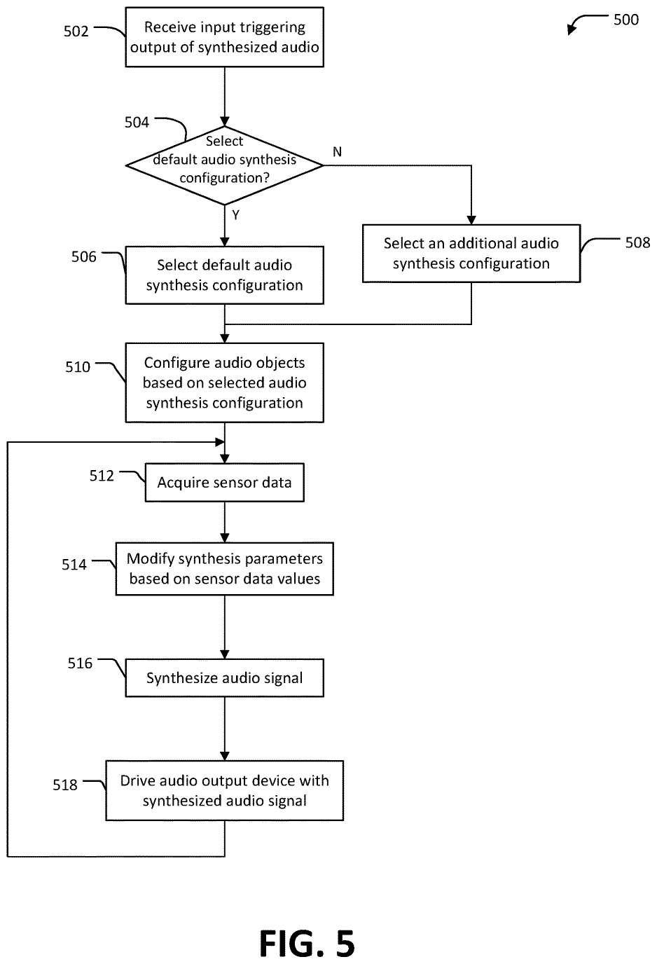

FIG. 5 sets forth a flow diagram of method steps for synthesizing an audio signal based on sensor inputs for output by an audio output device, according to various embodiments of the present disclosure. Although the method steps are described with reference to the systems of FIGS. 1-4, persons skilled in the art will understand that any system configured to implement the method steps, in any order, falls within the scope of the present disclosure.

As shown, method 500 begins at step 502, where the sound synthesis application 160 receives an input triggering an output of synthesized audio. In various embodiments, the sound synthesis application 160 can receive an input indicating that the sound synthesis application 160 is to produce a synthesized audio signal 330. In some embodiments, the input is a manual input from a user. For example, the user can press a button or provide an audio command that indicates that the client computing device 150 executing the sound synthesis application 160 is to produce a sound output 172 corresponding to the synthesized audio signal 330. Alternatively, in some embodiments, the sound synthesis application 160 detects a trigger based on acquired sensor data. In various embodiments, one or more sensors 190 can acquire sensor data 302 that includes one or more sensor data values 192. In such instances, the sound synthesis application 160 can determine that one of the sensor data values 192 indicates that the sound synthesis application 160 is to produce a sound output 172. For example, the sound synthesis application 160 can receive sensor data indicating proximity to an object and/or an ambient noise in an environment crosses a threshold level. In such instances, the sound synthesis application 160 can determine that the sensor data indicates that the client computing device 150 is to produce the sound output 172. Additionally or alternatively, in some embodiments, the input received to trigger the output of the synthesized audio signal 330 is accompanied by selection of a specific audio synthesis configuration 140. For example, the client computer device 150 can receive a voice command specifying that the client computing device 150 is to produce a sound and a particular audio synthesis configuration 140 to use. In another example, an object (e.g., an RFID tag) is moved in proximity to the client computing device 150. The sensor 190 detects the proximity of the RFID tag and that the RFID tag is associated with a particular audio synthesis configuration (e.g., the audio synthesis configuration 140(2)). In such instances, the detection of the RFID tag triggers selection of the particular audio synthesis configuration 140(2) and the output of the corresponding synthesized audio signal as the synthesized audio signal 330.

At step 504, the sound synthesis application 160 determines whether to select the default audio synthesis configuration for synthesis. In various embodiments, the client computing device 150 stores multiple audio synthesis configurations 140 that the sound synthesis application 160 uses to generate different synthesized audio signals 330, 430. In some embodiments, the sound synthesis application 160 is configured to select a default audio synthesis configuration 410 for synthesis. In some embodiments, the sound synthesis application 160 receives an input that indicates another stored audio synthesis configuration is to be used for synthesis. For example, upon the client computing device 150 becoming proximate to an external device 180 and downloading an audio synthesis configuration 140(2) stored in the external device 180, the sound synthesis application 160 can prompt the user to indicate whether the sound synthesis application 160 is to select the recently downloaded audio synthesis configuration 140.

When the sound synthesis application 160 determines that the default audio synthesis configuration 410 is to be selected, the sound synthesis application 160 proceeds to step 506, where the sound synthesis application 160 selects the default audio synthesis configuration 410 as the selected audio synthesis configuration 420. Otherwise, the sound synthesis application 160 determines that the default audio synthesis configuration 410 is not to be selected and proceeds to step 508, where the sound synthesis application 160 selects one of the additional audio synthesis configurations 140 in the client computing device 150 as the selected audio synthesis configuration 420.

At step 510, the sound synthesis application 160 configures the subset of audio objects 164 based on the selected audio synthesis configuration 420. In various embodiments, the sound synthesis application 160 loads information from the selected audio synthesis configuration 420 and configures the specified subset of audio objects 164 retrieved from the audio object library 162 stored in the client computing device 150. In various embodiments, the selected audio synthesis configuration 420 includes a netlist that specifies a selection of predefined audio objects 164 that are defined in the audio object library 162, as well as an arrangement of control signals 220 and/or audio signals 222, 224 that connect the respective audio objects. In some embodiments, the selected audio synthesis configuration 410 may also include a set of synthesis parameters that modify the operation of the respective audio objects. In such instances, the sound synthesis application 160 modifies the group of audio objects using the set of synthesis parameters.

At step 512, the sound synthesis application 160 acquires sensor data 302. In various embodiments, the sound synthesis application 160 receives sensor data 302 from one or more sensors 190 coupled to the client computing device 150. For example, the client computing device 150 receives sensor data 302 from a group of sensors 190 (e.g., light sensors, motion sensor, audio sensors, etc.). In some embodiments, the selected audio synthesis configuration 420 specifies that one or more synthesis parameters used to generate the synthesized audio signal 330 are a function of sensor data values 192 acquired by the group of sensors 190. In such instances, the sound synthesis application 160 acquires the sensor data 302 specified in the selected audio synthesis configuration 420.

At step 514, the sound synthesis application 160 modifies one or more synthesis parameters based on the sensor data values 192 included in the acquired sensor data 302. In various embodiments, the sound synthesis application 160 processes the sensor data 302 in real time or close to real time and extracts one or more sensor data values 192 from the acquired sensor data 302 and uses the sensor data values 192 to modify one or more synthesis parameters associated with the audio synthesis configuration 140. In some embodiments, the sound synthesis application 160 updates one or more control signals 312 with the sensor data values 192. For example, the sound synthesis application 160 can update a control signal 312 to include an unmodified or scaled sensor data value 192. In some embodiments, the sound synthesis application 160 can input the unmodified or scaled sensor data values 192 into one or more tuning parameters or control parameters that control the operation of one or more audio objects 164 based on the incoming sensor data values 192. For example, the sound synthesis application 160 can input one or more unmodified or scaled sensor data values 192 into a control signal or a tuning parameter set of a waveform generator. In such instances, the waveform generator produces an audio signal having an amplitude, frequency, phase, waveform type, or other characteristic that is a function of at least one sensor data value 192.

At step 516, the sound synthesis application 160 synthesizes the audio signal 330. In various embodiments, the sound synthesis application 160 executes the audio synthesis configuration (e.g., executing the configured computer code forming the arrangement of the subset of audio objects) to generate a synthesized audio signal 330. In some embodiments, the synthesized audio signal 330 is based on one or more unmodified or scaled sensor data values 192 included in acquired sensor data 302. In such instances, the sound synthesis application 160 continually processes acquired sensor data 302 and, based on the updated sensor data values 192, continually modifies the tuning parameters (e.g., the tuning parameters 146(3)) and/or the control parameters (e.g., the control parameters 148(3)) based on updated sensor data values 192, thereby modifying synthesized audio signal 330. In some embodiments, the sound synthesis application 160 modifies the tuning parameters and the control parameters while the arrangement of audio objects is executing to synthesize additional portions of the synthesized audio signal 330.

For example, the selected audio synthesis configuration 410 can specify that the amplitude of the oscillator audio output signal 222 generated by the oscillator 206 is a function of a velocity measurement acquired by a motion sensor. In such instances, the sound synthesis application 160 can continually receive updated scaled velocity measurements from the motion sensor and update the control inputs into the oscillator 206 with the updated scaled velocity data 302. As the oscillator 206 receives new control input values, the oscillator 206 can continually output the oscillator audio output signal 222 based on the velocity measurement, causing the synthesized audio signal 330 to change in character as the velocity measurement changes. In various embodiments, for systems generating digital audio, a group of samples, called a block, is computed simultaneously. In some embodiments, the sound synthesis application 160 continually processes acquired sensor data 302 and updates the control input to oscillator 206 with scaled sensor data values 192 (e.g., one update per time frame), such that sequential frames of the audio output are based on sequential sensor data values 192. In such instances, the sequential frames create a perception of real-time interactivity of the synthesized sound and velocity.

At step 518, the sound synthesis application 160 drives the audio output device 170 with the synthesized audio signal. In various embodiments, the sound synthesis application 160 transmits the synthesized audio signal 330 to the audio output device 170 for reproduction. In some embodiments, the client computing device 150 continually transmits sequential samples and/or sequential blocks of audio samples to the audio output device 170 as the audio synthesis configuration synthesizes the audio signal. In some embodiments, the sound synthesis application 160 drives the audio output device 170 to reproduce all of the sequential blocks of audio samples in the synthesized audio signal 330 a single time. Alternatively, in some embodiments, the sound synthesis application 160 drives the audio output device 170 to repeatedly reproduce the synthesized audio signal 330 until the sound synthesis application 160 receives an input from the user indicating that the client computing device 150 is to stop producing the synthesized audio signal. In some embodiments, the audio is continuously synthesized until sensor data value 192 indicates that audio synthesis should be terminated.

For example, the sound synthesis application 160 determines that the client computing device 150 is no longer proximate to an object. In such instances, the client computing device 150 stops transmitting sequential blocks of audio to the audio output device. In another example, the sound synthesis application 160 stops executing the audio synthesis configuration 140. In some embodiments, different audio synthesis configurations 140 correspond to the sound synthesis application 160 generating audio that produces sound of a specific length of time that is continuously repeated. In some instances, the sound synthesis application 160 repeats generating the audio until a sensor 190 indicates an object is no longer proximate. In such instances, the sound synthesis application 160 finishes repetition of the audio, refraining from a new repetition the object is again proximate. Upon driving client computing device 150 to transmit the blocks of audio to the audio output device 170, the sound synthesis application 160 can return to step 512 to receive additional sensor data.

In sum, a client computing device executing a sound synthesis application receives an audio synthesis configuration specifying the audio objects, tuning parameters, and control signals that are to be used to synthesize an audio signal. The audio synthesis configuration includes a signal flow that specifies the arrangement of elements and components from a library of audio objects that are to be used, and the control signals and tuning parameters that specify synthesis parameters for the respective audio objects. Based on the audio synthesis configuration, the client computing device configures the audio objects into a specific arrangement in the manner specified in the audio synthesis configuration. The sound synthesis application uses the arrangement of audio objects to synthesize the audio signal in real time. In some embodiments, the audio synthesis configuration specifies that one or more control signals or tuning parameters associated with the audio objects are functions of values included in acquired sensor data. In such instances, the sound synthesis application synthesizes the audio signal by using the values or the scaled values from acquired sensor data to configure the one or more control parameters or tuning parameters.

At least one technological advantage of the sound synthesis application relative to the prior art is that, with the disclosed techniques, the sound synthesis application can generate a large variety of sounds in real time using a small microprocessor and memory. Another advantage is that the sound synthesis application is able to alter the generated sound based on sensor inputs so as to customize the sound based on changes in the environment. Generating sounds based on environmental factors enables the sound synthesis application to generate multiple sound outputs using a limited library of data stored in the memory. Such techniques increase the variety of sounds that the device can produce, increasing the usefulness of the device producing the synthesized sounds. These technical advantages provide one or more technological advancements over prior art approaches.

1. In various embodiments, a computer-implemented method comprises generating, based on a first audio synthesis configuration, an arrangement including at least one audio object to synthesize an audio signal, receiving sensor data acquired from a set of sensors, modifying the arrangement based on the sensor data to generate a modified arrangement, activating the modified arrangement to generate a synthesized audio signal, and outputting, using an audio output device, an audio reproduction of the synthesized audio signal.

2. The computer-implemented method of clause 1, where the arrangement further includes a set of synthesis parameters that modify operation of the at least one audio object when synthesizing the audio signal, and the sensor data includes at least a first sensor data value that modifies a first synthesis parameter included in the set of synthesis parameters.

3. The computer-implemented method of clause 1 or 2, further comprising receiving an input from a user to output the audio reproduction, and retrieving the first audio synthesis configuration from a local storage device.

4. The computer-implemented method of any of clauses 1-3, where the first audio synthesis configuration is a default audio synthesis configuration from a set of one or more stored audio synthesis configurations.

5. The computer-implemented method of any of clauses 1-4, further comprising receiving an input from a user to output the audio reproduction, where the input indicates outputting a sound corresponding to a non-default audio synthesis configuration, and selecting, from a set of audio synthesis configurations stored in a local storage device, the first audio synthesis configuration.

6. The computer-implemented method of any of clauses 1-5, further comprising detecting an external device, and acquiring a second audio synthesis configuration from the external device.

7. The computer-implemented method of any of clauses 1-6, where the external device stores the second audio synthesis configuration in a storage device, or includes a tag that includes an encoded version of the second audio synthesis configuration.

8. The computer-implemented method of any of clauses 1-7, further comprising upon outputting the audio reproduction of the synthesized audio signal, receiving second sensor data acquired from the set of sensors, and in response to receiving the second sensor data, modifying the arrangement based on the second sensor data to generate a second modified arrangement, activating the second modified arrangement to generate a second synthesized audio signal, and outputting, using the audio output device, an audio reproduction of the second synthesized audio signal.

9. The computer-implemented method of any of clauses 1-8, where the at least one audio object comprises a pre-defined audio object specified in an audio object library, and generating the arrangement comprises loading the pre-defined audio object from the audio object library.

10. The computer-implemented method of any of clauses 1-9, where the pre-defined audio object is selected from a group consisting of a noise generator, a waveform generator, an amplitude controller, a mixer, a control signal modulator, a control signal generator, a frequency equalizer, and a filter.

11. In various embodiments, one or more non-transitory computer-readable media store instructions that, when executed by one or more processors, cause the one or more processors to perform the steps of generating, based on a first audio synthesis configuration, an arrangement including at least one audio object to synthesize an audio signal, receiving sensor data acquired from a set of sensors, modifying the arrangement based on the sensor data to generate a modified arrangement, activating the modified arrangement to generate a synthesized audio signal, and outputting, using an audio output device, an audio reproduction of the synthesized audio signal.

12. The one or more non-transitory computer-readable media of clause 11, where the arrangement further includes a set of synthesis parameters that modify operation of the at least one audio object when synthesizing the audio signal, and the sensor data includes at least a first sensor data value that modifies a first synthesis parameter included in the set of synthesis parameters.

13. The one or more non-transitory computer-readable media of clause 11 or 12, further comprising instructions that, when executed by the one or more processors, cause the one or more processors to perform the steps of upon outputting the audio reproduction of the synthesized audio signal, receiving second sensor data acquired from the set of sensors, and in response to receiving the second sensor data, modifying the arrangement based on the second sensor data to generate a second modified arrangement, activating the second modified arrangement to generate a second synthesized audio signal, and outputting, by the processor using the audio output device, an audio reproduction of the second synthesized audio signal.

14. The one or more non-transitory computer-readable media of any of clauses 11-13, where the at least one audio object comprises a pre-defined audio object specified in an audio object library, and generating the arrangement comprises loading the pre-defined audio object from the audio object library.

15. The one or more non-transitory computer-readable media of any of clauses 11-14, further comprising instructions that, when executed by the one or more processors, cause the one or more processors to perform the steps of receiving an input from a user to output the audio reproduction, and retrieving the first audio synthesis configuration from a local storage device.

16. The one or more non-transitory computer-readable media of any of clauses 11-15, further comprising instructions that, when executed by the one or more processors, cause the one or more processors to perform the steps of receiving an input from a user to output the audio reproduction, wherein the input indicates outputting a sound corresponding to a non-default audio synthesis configuration, and selecting, from a set of audio synthesis configurations stored in a local storage device, the first audio synthesis configuration.

17. The one or more non-transitory computer-readable media of any of clauses 11-16, further comprising instructions that, when executed by the one or more processors, cause the one or more processors to perform the steps of detecting an external device, and acquiring a second audio synthesis configuration from the external device, where the external device stores the second audio synthesis configuration in a storage device, or includes a tag that includes an encoded version of the second audio synthesis configuration.

18. In various embodiments, an interactive toy outputs a synthesized audio signal, the interactive toy comprising at least one sensor that acquires sensor data, and a computing device that generates, based on a first audio synthesis configuration, an arrangement including at least one audio object to synthesize an audio signal, receives the sensor data, modifies the arrangement based on the sensor data to generate a modified arrangement, activates the modified arrangement to generate a synthesized audio signal, and outputs, using an audio output device, an audio reproduction of the synthesized audio signal.

19. The interactive toy of clause 18, where the at least one sensor comprises at least one of an optical sensor, a potentiometer, a proximity sensor, a motion sensor, or a pressure sensor.

20. The interactive toy of clause 18 or 19, where the computing device includes a low-power digital processor that modifies the arrangement.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
generating, based on a first audio synthesis configuration, an arrangement including at least one audio object to synthesize an audio signal;
receiving sensor data acquired from a set of sensors;
modifying the arrangement based on the sensor data to generate a modified arrangement;
activating the modified arrangement to generate a synthesized audio signal; and
outputting, using an audio output device, an audio reproduction of the synthesized audio signal.

2. The computer-implemented method of claim 1, wherein:
the arrangement further includes a set of synthesis parameters that modify operation of the at least one audio object when synthesizing the audio signal; and
the sensor data includes at least a first sensor data value that modifies a first synthesis parameter included in the set of synthesis parameters.

3. The computer-implemented method of claim 1, further comprising:
receiving an input from a user to output the audio reproduction; and
retrieving the first audio synthesis configuration from a local storage device.

4. The computer-implemented method of claim 3, wherein the first audio synthesis configuration is a default audio synthesis configuration from a set of one or more stored audio synthesis configurations.

5. The computer-implemented method of claim 1, further comprising:
receiving an input from a user to output the audio reproduction, wherein the input indicates outputting a sound corresponding to a non-default audio synthesis configuration; and
selecting, from a set of audio synthesis configurations stored in a local storage device, the first audio synthesis configuration.

6. The computer-implemented method of claim 1, further comprising:
detecting an external device; and
acquiring a second audio synthesis configuration from the external device.

7. The computer-implemented method of claim 6, wherein the external device:
stores the second audio synthesis configuration in a storage device; or
includes a tag that includes an encoded version of the second audio synthesis configuration.

8. The computer-implemented method of claim 1, further comprising:
upon outputting the audio reproduction of the synthesized audio signal, receiving second sensor data acquired from the set of sensors; and
in response to receiving the second sensor data:
modifying the arrangement based on the second sensor data to generate a second modified arrangement;
activating the second modified arrangement to generate a second synthesized audio signal; and
outputting, using the audio output device, an audio reproduction of the second synthesized audio signal.

9. The computer-implemented method of claim 1, wherein:
the at least one audio object comprises a pre-defined audio object specified in an audio object library; and
generating the arrangement comprises loading the pre-defined audio object from the audio object library.

10. The computer-implemented method of claim 9, wherein the pre-defined audio object is selected from a group consisting of a noise generator, a waveform generator, an amplitude controller, a mixer, a control signal modulator, a control signal generator, a frequency equalizer, and a filter.

11. One or more non-transitory computer-readable media storing instructions that, when executed by one or more processors, cause the one or more processors to perform the steps of:
generating, based on a first audio synthesis configuration, an arrangement including at least one audio object to synthesize an audio signal;
receiving sensor data acquired from a set of sensors;
modifying the arrangement based on the sensor data to generate a modified arrangement;
activating the modified arrangement to generate a synthesized audio signal; and
outputting, using an audio output device, an audio reproduction of the synthesized audio signal.

12. The one or more non-transitory computer-readable media of claim 11, wherein:
the arrangement further includes a set of synthesis parameters that modify operation of the at least one audio object when synthesizing the audio signal; and
the sensor data includes at least a first sensor data value that modifies a first synthesis parameter included in the set of synthesis parameters.

13. The one or more non-transitory computer-readable media of claim 11, further comprising instructions that, when executed by the one or more processors, cause the one or more processors to perform the steps of:
upon outputting the audio reproduction of the synthesized audio signal, receiving second sensor data acquired from the set of sensors; and
in response to receiving the second sensor data:
modifying the arrangement based on the second sensor data to generate a second modified arrangement;
activating the second modified arrangement to generate a second synthesized audio signal; and
outputting, by the processor using the audio output device, an audio reproduction of the second synthesized audio signal.

14. The one or more non-transitory computer-readable media of claim 11, wherein:
the at least one audio object comprises a pre-defined audio object specified in an audio object library; and
generating the arrangement comprises loading the pre-defined audio object from the audio object library.

15. The one or more non-transitory computer-readable media of claim 11, further comprising instructions that, when executed by the one or more processors, cause the one or more processors to perform the steps of:
receiving an input from a user to output the audio reproduction; and
retrieving the first audio synthesis configuration from a local storage device.

16. The one or more non-transitory computer-readable media of claim 11, further comprising instructions that, when executed by the one or more processors, cause the one or more processors to perform the steps of:
receiving an input from a user to output the audio reproduction, wherein the input indicates outputting a sound corresponding to a non-default audio synthesis configuration; and
selecting, from a set of audio synthesis configurations stored in a local storage device, the first audio synthesis configuration.

17. The one or more non-transitory computer-readable media of claim 11, further comprising instructions that, when executed by the one or more processors, cause the one or more processors to perform the steps of:
detecting an external device; and
acquiring a second audio synthesis configuration from the external device,
wherein the external device stores the second audio synthesis configuration in a storage device, or includes a tag that includes an encoded version of the second audio synthesis configuration.

18. An interactive toy that outputs a synthesized audio signal, the interactive toy comprising:
at least one sensor that acquires sensor data; and
a computing device that:
generates, based on a first audio synthesis configuration, an arrangement including at least one audio object to synthesize an audio signal;
receives the sensor data;
modifies the arrangement based on the sensor data to generate a modified arrangement;
activates the modified arrangement to generate a synthesized audio signal; and
outputs, using an audio output device, an audio reproduction of the synthesized audio signal.

19. The interactive toy of claim 18, wherein the at least one sensor comprises at least one of an optical sensor, a potentiometer, a proximity sensor, a motion sensor, or a pressure sensor.

20. The interactive toy of claim 18, wherein the computing device includes a low-power digital processor that modifies the arrangement.
